(19) United States
(12) Patent Application Publication
(10) Pub. No.: US 2026/0259815 A1
(43) Pub. Date: Sep. 3, 2026

(54) RECURSION STABILITY TRACKER

(71) Applicant: Alan Joseph GALLAURESI, Berwyn Heights, MD (US)

(72) Inventor: Alan Joseph GALLAURESI, Berwyn Heights, MD (US)

(21) Appl. No.: 19/545,598

(22) Filed: Feb. 20, 2026

Related U.S. Application Data
(60) Provisional application No. 63/761,702, filed on Feb. 21, 2025.

(51) Int. Cl. G06F 11/34; G06F 16/901; G06N 5/00

(52) U.S. Cl. CPC G06F 11/3466; G06F 16/9024; G06N 5/00

(57) ABSTRACT

Various aspects of the disclosure relate to computer-implemented techniques for managing stability of iterative or recursive state transitions. The system accesses candidate recursion states and creates immutable units of information stored as state records in a non-erasing storage mechanism, such that each record represents a respective state, computation, or decision and remains distinct from prior records. Evaluation rules are applied, including predefined ethical parameters and transformation gating thresholds, to generate and immutably store scoring results comprising a stability-related alignment score that tracks recursion shifts across state transitions. Recursion stability is enforced by permitting transformation, propagation, or structural expansion of a given state record based on the transformation gating thresholds. Rollback is restricted by generating lock records for accepted state records that satisfy the gating threshold and enforcing time-sequenced locking that preserves an immutable, timestamp-ordered recursion history.

### CROSS-REFERENCE TO RELATED APPLICATIONS

This application claims the benefit of U.S. Provisional Patent Application No. 63/761,702 filed on Feb. 21, 2025, the contents of which are hereby incorporated by reference herein in their entirety, for all purposes.

### TECHNICAL FIELD

The present disclosure relates generally to computational governance and recursive decision systems. In particular, some aspects of the disclosure may relate to stability-tracked recursive state transitions using alignment-based scoring, immutable directed acyclic graph (DAG) state recording, and threshold-gated, ethically constrained transformation control to prevent rollback, contradiction, or adversarial manipulation in domains including AI governance, legal precedent tracking, and economic modeling.

### DESCRIPTION OF RELATED ART

Recursive and iterative decision systems are widely used in modern computing, including machine-learning model training and fine-tuning, automated policy or ruleset updates, legal analytics based on citation networks, and economic or financial simulations that repeatedly re-parameterize models based on prior outputs. In such systems, each update step may depend on one or more prior states, and the system's behavior over time emerges from the cumulative effect of many successive transitions. As these applications have expanded, so too has the need for mechanisms that can evaluate whether iterative changes remain consistent with intended constraints, safety requirements, and operational objectives.

Conventional approaches for managing iterative updates typically rely on periodic testing, model cards or documentation, manual governance reviews, and general-purpose version control or logging. While these tools can capture artifacts (e.g., code versions, datasets, model checkpoints, or policy documents), they often do not provide a unified, structured representation of the full lineage of state transitions coupled with the specific evaluation criteria applied at each step. In practice, assessments are frequently performed on isolated snapshots, and the rationale for accepting or rejecting a given update may be stored in narrative form or in systems not tightly bound to the underlying state history.

These limitations can create technical and operational risks. Iterative systems may drift as small changes compound, and inconsistencies may only become apparent after deployment or after multiple iterations. In addition, where prior states can be overwritten, selectively ignored, or difficult to reconstruct, it may be challenging to audit how a particular outcome arose or to establish accountability for changes over time. This can be problematic in automated compliance, safety-critical decision support, or legal and policy reasoning where traceability and reproducibility are necessary for validation, dispute resolution, or regulatory review.

Further, existing governance controls may be vulnerable to manipulation or incomplete provenance. For example, actors may influence outcomes by selectively choosing which inputs, precedents, evaluation metrics, or test sets are treated as authoritative for a given iteration. In distributed or multi-actor environments, disagreements about ordering, authorship, or the “current” accepted state can also arise, complicating verification and increasing the difficulty of ensuring that iterative changes remain bounded by consistent constraints across time and across systems.

### BRIEF SUMMARY OF THE DISCLOSURE

Aspects of the present disclosure provide a computer-implemented method, program products, and systems for a recursion stability tracking system for managing iterative or recursive state transitions in computational decision environments. The system applies a governing function to recursive structures to assign stability and alignment scores to recursive states, represents those states and their transitions in a traceable data structure, and enforces threshold-based gating to control when recursive expansions or transformations are permitted. In some embodiments, the system further enables validation by external auditors with scoped access to sensitive data through verifiable scoring criteria and traceable evaluation records, prevents adversarial collapses by enforcing state persistence and measurable alignment shifts across recursion steps, and ensures cross-domain consistency such that the system is adaptable to applications including AI ethics, machine-learning models, and computational law.

Various aspects of the invention relate to a recursion stability tracking system that measures the stability of recursive state transitions, enforces meltdown-free expansion, and evaluates readiness for structural transformation in domains such as AI governance, legal precedent tracking, and economic modeling. The system assigns an alignment score to data and recursive expansion states, then represents these states and their transitions in a Directed Acyclic Graph (DAG). This DAG encodes an irreversible recursion model in which each operation is traceable, non-erasable, and constrained by predefined ethical parameters, thereby enabling predictable and auditable convergence and repeatable verification of results.

This system may provide a clear separation of components by separating the process into three distinct parts: (1) a Data Input Set (DIS), an external input corpus of data provided to the system; (2) a versioned set of System Level Constraints (SLC) which define the secure rules for evaluation, validation, and tracking; and (3) Runtime Bundled Parameters (RBP) which define the specific scoring mechanisms used within the bounds set by the SLC. The system supports variation in scoring evaluators, data-set filtering, and subject-matter domains while maintaining end-to-end traceability and comparability of recursion states over time, and guarantees the traceability and stability of recursion scoring rather than the perfection of any particular evaluation criterion.

In some embodiments, the system creates and stores immutable units of information, termed pinions, where each pinion represents a specific state, computation, or decision within a recursive process. In some embodiments, a “state record” may refer to any immutable record that represents or is associated with a recursion state, computation, or decision, including without limitation a pinion, a pinion_record, a pinion_score, and/or a pinion_lock, and the term “state record” may be used interchangeably with “pinion” in contexts where a pinion represents the immutable unit of information. Vetraxis measures the recursion stability of each pinion (e.g., recursion stability metric) at index n in the DIS using a state alignment function A(n), a dynamically calculated value in the normalized range [0, 1], representing the pinion's alignment with the system's criteria for difference, harmony, and ethical compliance, and thereby providing a consistent stability score. The system defines a transformation trigger by determining when recursion states are sufficiently stable for expansion based on a predefined threshold for A(n), such that a state is eligible for transformation only when its stability score meets or exceeds the threshold. This metric is a dynamically calculated value in the normalized range [0, 1], representing the pinion's alignment with the system's criteria for difference, harmony, and ethical compliance, and thereby providing a consistent stability score

In some embodiments, this system may enforce a meltdown-free expansion rule such that once a recursion state has been accepted as stable, its representation is immutable. This is enforced through a logical DAG structure and time-sequenced locking, preventing destructive updates to past states. Each pinion is assigned a unique, monotonically increasing timestamp, creating an immutable historical sequence, preventing rollback exploits, and ensuring that all changes can be reconstructed and audited in order. In some embodiments, the system includes a locking and auditability layer that records evaluation provenance and transformation readiness decisions in a verifiable and auditable trail, and prevents acceptance of new recursion states that violate predefined stability or ethical constraints.

Some embodiments may further provide a pluggable, trace-locked evaluation layer: any scoring algorithm (e.g., rule-based, statistical, or AI-based) may be used, provided its full configuration bundle is hash-recorded before scoring. Changing the scoring algorithm requires a separate evaluation pass, leaving the original alignment record immutable while still preserving universal ethical minimums and transformation rules. The system supports domain-specific scoring, including domain-specific weighting of data for particular use cases (e.g., legal, financial, technical), with all scoring remaining attached to an auditable and verifiable trail enabling transparent evaluation and decision-making.

The recursion stability system supports multiple implementation options across software, hardware, and distributed environments, and may operate within AI inference engines, policy-evaluation frameworks, or cryptographic attestation systems depending on deployment needs. Hardware may be used for performance or security optimization (e.g., real-time enforcement via accelerators, secure modules, or tamper-resistant computing) but hardware use is optional, and the system's guarantees remain valid across all supported computational configurations.

According to some embodiments, a system comprises a computer-implemented system programmed with computer instructions including a data ingestion and pinion recording module, a versioned constraints management module, a scoring and alignment evaluation module, an immutable recursion history module implemented using a directed acyclic graph (DAG), and a locking and auditability module that records evaluation provenance and transformation readiness decisions.

As an example, some implementations may include a system and method for recursion stability enforcement, the method being performed by one or more processors programmed with program instructions which, when executed, cause the one or more processors to perform steps including: receiving a data input set comprising candidate recursion states; recording each candidate state as an immutable unit of information (a “pinion”) in append-only storage together with timestamps and cryptographic digests; applying one or more evaluator bundles defined by runtime bundled parameters to generate component scores for each pinion; computing an alignment score for a pinion as a function of a prior alignment score and an observed performance score; determining whether the pinion satisfies a transformation readiness threshold; and, when the threshold is satisfied, generating an immutable lock record for the pinion that is auditable and re-runnable under the recorded criteria.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto and their equivalents thereof.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a functional block diagram illustrating a computing environment, in accordance with various embodiments of the systems and methods disclosed herein.

FIG. 2 is a block diagram illustrating a separation and feedback process, in accordance with various embodiments of the systems and methods disclosed herein.

FIG. 3 is an example of operational steps illustrating a pinion demonstration, in accordance with of the systems and methods disclosed herein.

FIG. 4 is an example pinion scoring set, in accordance with various embodiments of the systems and methods disclosed herein.

FIG. 5 is an example diagram for placing 3 pinions into a pinion DAG, in accordance with various embodiments of the systems and methods disclosed herein.

FIG. 6 is an example diagram for expanding a pinion DAG, in accordance with various embodiments of the systems and methods disclosed herein.

FIG. 7 is an alternate functional block diagram illustrating a computing environment, in accordance with various embodiments of the systems and methods disclosed herein.

FIG. 8 is a flowchart depicting an example of operational steps for managing stability of iterative or recursive state transitions, in accordance with various embodiments of the systems and methods disclosed herein.

FIG. 9 depicts a block diagram of components of the computing systems of FIG. 1, in accordance with various embodiments of the systems and methods disclosed herein.

### DETAILED DESCRIPTION

Recursive systems in AI, decision theory, law, and other decision environments typically involve repeated state transitions in which each new output influences subsequent operations. In practice, such recursive expansion frequently requires a mechanism to determine when an expanding structure has reached a stable or ethically acceptable state. However, in many state-of-the-art implementations, recursion remains effectively unconstrained, such that the system lacks an objective, machine-enforceable way to determine whether further expansion is stable, unstable, or ethically unacceptable.

Existing recursive processes are often unbounded, in that there is no governing function that indicates when additional recursion should be permitted or blocked. Existing approaches are also frequently opaque, because prior recursion states may be overwritten, summarized without preserving the full state, or not explicitly represented in a manner that supports verification. This opacity can prevent meaningful auditability, frustrate reproducibility, and limit the ability to perform rollback or re-evaluation against the actual recursion history. Further, recursive processes are commonly exploitable, in that adversarial actors can manipulate policy updates, model revisions, or precedent selection to bypass informal convergence checks and steer outcomes while leaving an incomplete or misleading record of how the system arrived at a given state.

These deficiencies manifest in multiple technical domains. In AI and ML governance, reinforcement learning and policy-optimization systems can drift under repeated updates, and alignment tests may be applied to isolated snapshots rather than the full recursion path, allowing misaligned behaviors to emerge over time even if individual steps appear acceptable in isolation. In legal precedent tracking, case law evolves through citation chains without explicit structural constraints, and selective citation or omission of precedents can enable “recursion hacking,” where legal outcomes are steered by manipulating which prior states are treated as relevant. In economic decision systems, recursive policy and risk models (including macroeconomic simulations and automated trading strategies) adjust parameters based on prior outputs, and in the absence of stability enforcement, small biases can compound into large, unpredictable, or catastrophic outcomes.

In these environments, conventional tooling lacks a formalized construct that both (i) represents the full recursion history as an immutable structure, and (ii) evaluates whether each new recursion step is consistent, stable, and ethically bounded relative to that history. As a result, instabilities can accumulate silently across iterations, misalignment can emerge despite apparently successful point-in-time testing, and there may be no enforceable linkage between “pass/fail” evaluations and the actual structure of recursion over time.

To address these technical deficiencies, the disclosed system provides a recursion stability tracking framework that, at minimum, implements: (1) alignment tracking across expansion layers, (2) meltdown-free growth (non-erasing history), and (3) transformation readiness thresholds. In accordance with these requirements, each recursion step is represented as a distinct, addressable state, and an alignment score or related metric is assigned to each state and, in some embodiments, to transitions between states. A structural relationship is preserved—such as via a Directed Acyclic Graph (DAG) —so that the cumulative effect of recursive changes is inspectable and auditable rather than inferred from isolated snapshots.

The system further enforces meltdown-free growth by guaranteeing that prior recursion states remain unchanged and retrievable even as new states are added. Destructive updates that overwrite or delete evidence of prior alignment, misalignment, or instability are prevented, such that rollback or re-evaluation is performed against a complete, non-erased recursion history. In addition, the system defines transformation readiness thresholds using quantitative or rule-based thresholds that indicate when a system is stable enough to be deployed or escalated (e.g., from test to production), or when a transformation (e.g., policy change, model update, or legal doctrine shift) is permitted, and treats these thresholds as formal gating conditions rather than informal guidelines.

In operation, Vetraxis implements recursion stability as an explicit, machine-enforced tracking function, not a human-only oversight process. Each recursion step is recorded in a DAG of states and transitions with associated alignment scores, and the system prevents acceptance of new recursion states that violate predefined stability or ethical constraints. In this manner, the system functions as a self-reinforcing recursion tracker that not only measures recursion stability but also constrains future recursion based on the accumulated, immutable history of prior states.

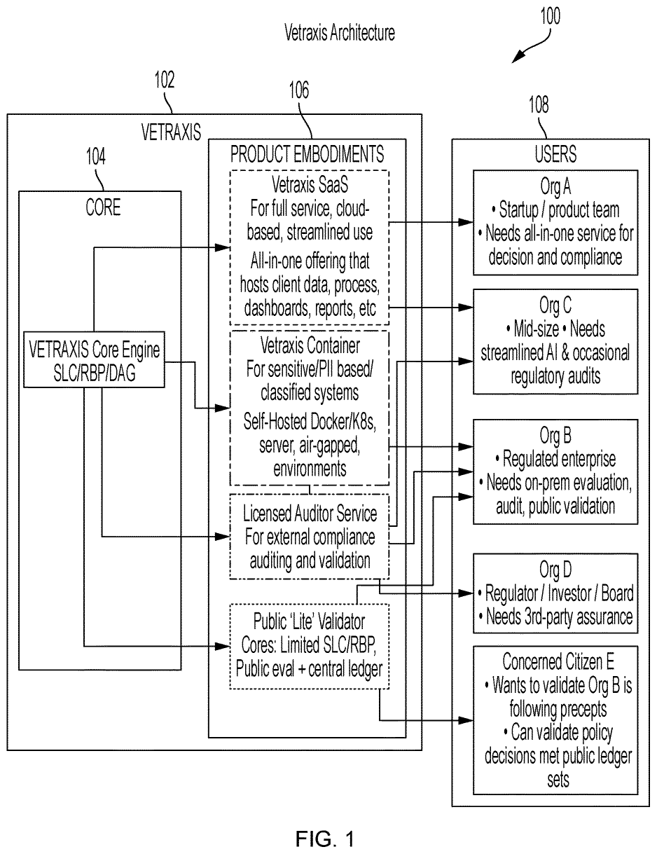

FIG. 1 is a functional block diagram illustrating computing environment 100, in accordance with various embodiments of the systems and methods disclosed herein.

For example, computing environment 100 illustrates an example environment diagram in which Vetraxis 102 includes a core 104 and product embodiments 106, and is accessed by users 108. Vetraxis may be deployed in several ways. In all embodiments, it uses: a versioned set of System Level Constraints (SLC), one or more Runtime Bundled Parameters (RBP) for scoring, and a Pinion Directed Acyclic Graph (DAG) as the immutable history of locked pinions. A pinion, as used herein may refer to an immutable unit of information representing a specific state, computation, or decision within the recursive process. The following are non-limiting examples. Vetraxis 102 may have multiple embodiments 106 as discussed in greater detail below.

In one embodiment, Vetraxis 102 may run as a hosted SaaS service: The provider hosts the SLCs, RBPs, scoring engine, and Pinion DAG. Clients integrate over secure APIs or connectors, sending candidate pinions for evaluation. In some embodiments, candidate pinions comprise a plurality of candidate recursion states associated with iterative or recursive state transitions, and may be received, generated, or accessed by Vetraxis 102 from one or more sources. Vetraxis 102 scores and, if thresholds are met, locks pinions, and exposes dashboards/APIs for viewing recursion stability and ethical compliance. Additional capabilities such as reporting, downloadable audit trails, automatically feeding into a LLM knowledge base or data lake for reporting may be offered. Here, the provider maintains both the configuration (SLC/RBP) and the canonical recursion history.

In another embodiment, Vetraxis 102 is a self-hosted product: Installed on cloud, on-premise servers, containers, or air-gapped machines. The organization controls its own SLC/RBP sets and its Pinion DAG. All scoring and locking occur within the organization's environment; external connectivity is optional. This gives full internal control over configuration, data, and recursion history.

In a further embodiment, Vetraxis is operated by an independent auditor and/or a third party assurance service: The auditor runs Vetraxis (SaaS or self-hosted) with shared SLCs and domain-specific RBPs. Client systems are connected or sampled securely; pinions are scored and locked into an audit Pinion DAG. The auditor issues signed reports or hashes showing which models/policies were evaluated under which constraints, and whether they met required thresholds. Optionally, organizations can choose to publish the work product of the validated chains publicly for later disclosure of private pinion data. This supports external verification without exposing full internal systems.

In another embodiment, Vetraxis supports many parallel instances anchored by a central provenance ledger: Organizations run local Vetraxis instances with their own SLC/RBP sets, and produce signed records for locked pinions. A central ledger (e.g., append-only log or blockchain-style system) records: digests of locked pinions, scores and key metadata, and identifiers of the SLC/RBP used. Local instances keep their data private; the central ledger provides provenance, cross-checkable consistency, and a shared record of recursion stability decisions.

These embodiments show the Vetraxis 102 may be implemented as a hosted service, a self-contained internal system, an auditor run assurance tool, or a federated system with a shared ledger while preserving non-erasing recursion history, stability gating, and ethically constrained state locking.

### Core Architect: Data Input Set (DIS), System Level Constraints (SLC) vs Runtime Bundled Parameters (RBP)

Vetraxis 102 fundamentally separates the data input set (DIS) from Vetraxis itself. Core 104 includes the core systemic constraints (SLC) and from runtime bundled parameters (RBP) that are bound to a specific scoring/locking set. A data input set (DIS) is any set of data where each element has “content”-a textual representation. Vetraxis 102 treats all DIS as non-authoritative and separate from the SLC and RBP. System level constraints (SLC) represent the “core profile” system of Vetraxis 102 as a versioned system, and include and specify as valid for a versioned instance of Vetraxis 102: Alignment function, noted as A(n); Weighted ethical minimum scalar, noted as w_e; Transformation threshold scalar, noted as tt; Validator functions, such as public hashing/cryptographic methods; Boundary limits, such as giving minimum and maximum weighting to RBC parameters (e.g. t window bounds for A_smooth, etc.). The process itself, embedded as steps in human and machine-readable format, including logic and code. In some embodiments, the SLC, alone or in combination with one or more Runtime Bundled Parameters (RBP), defines evaluation rules used to evaluate candidate recursion states and to generate scoring results, and such evaluation rules may include predefined ethical parameters and one or more transformation gating thresholds (including without limitation tt and/or rule-based gating conditions)

Core 104 may SLC is split from scoring runtime bundled parameters (RBP) which are also required to be validatable, traceable and repeated: but may be privately kept while still verifiable at a later state through public hashed attribution. This allows scoring to be work-product that is publicly verifiable as consistent, and can later be revealed to be calculated with rigor, without requiring exposure of scoring unless required for legal or other reasons.

The runtime bundled parameters (RBP) include: Specific scoring evaluator implementation used in A(n), noted as S(n) (e.g. SAT solver, ontology checker, LLM prompt program, etc.); Domain specific weighting scalars for application, noted as weighted terms (w_d, w_h, w_e); Learning rate, noted as “k”; Any additional weighting required for scoring evaluators, specific to evaluators (e.g. AI model “p” temperature settings, etc.); A particular pinion_storage filesystem or mechanism that meets the criteria for immutable, timestamped, and hashed storage that can store and retrieve. In some embodiments, the RBP may also be referred to as one or more runtime parameter bundles that define a scoring evaluator implementation and one or more scoring weights used within bounds established by the system-level constraints (SLC). Crucially, these RBP must also be cryptographically encoded in reconstructable form (e.g. “public AI model+system prompt+additional training input set”) in the act of scoring to ensure valid repeatability by being a parameterized and fully reconstructable state.

Together the public Vetraxis core versioned SLC and RBP ensure full repeatability of process with privacy. This follows a consistent process by which: 1. The input data (DIS) is separate from Vetraxis 2. Vetraxis contains a set of versioned SLC (subgraph is versioned with 3 examples) and set of RBP (subgraph is specific with 3 examples) 3. Each feed from DIS goes into Vetraxis and then can feed back in as a separate DIS from the results.

Vetraxis 102 may assign a stability score A(n) in [0,1] to each pinion p at DIS index “n”, “Locking” a pinion—considering it permanently stable—occurs when the transformation threshold “tt” reaches a core system constraint value.
Pinion Storage and Merge Mechanics: pinion_storage (core 104; interactions with users 108)

In practical implementations, each pinion must be written directly into append-only storage (immutable, timestamped, directionally relational), using content-addressed formats such as Git object graphs, Merkle DAGs, or similar version-control-like systems. Such append-only storage is an example of a non-erasing storage mechanism in which prior state records remain unchanged and retrievable as additional state records are added. In some embodiments, the non-erasing storage mechanism may include one or more append-only logs, ledgers, databases, object graphs, Merkle DAGs, or other storage systems that prevent destructive updates to previously recorded state records. These raw pinions serve as immutable recursion snapshots that record an accurate datetime stamp of recording with a complete revision history. For systems operating across distributed environments, CRDT (Conflict-Free Replicated Data Type) techniques may be employed to merge pinions deterministically, allowing multiple agents to contribute to the recursion process without creating rollback risks. These merge strategies respect the meltdown-free constraints by enforcing directional, non-overlapping pinion insertions, and may use CRDT resolution to maintain consistency across multiple writers without requiring rollback or centralized locking. Since this merge process can happen idempotently after the pinions are recorded, it allows for dynamic reprocessing of data for the most stable “slices” of topology. This approach enables Vetraxis to operate across decentralized systems, version-controlled environments, or embedded policy engines with full traceability.

### Criteria-Hash Locking:

For every scored pinion the system records two immutable digests: 1. criteria_hash—a cryptographic hash (e.g., SHA-256 or BLAKE3) of the exact RBP evaluator bundle used to generate the score, including model identity, version, weights, rules, and any filter parameters. 2. chain_root—a running Merkle accumulator that appends criteria_hash to the prior root, producing an ever-extending proof-of-evaluation lineage. This guarantees that each evaluation is permanently traceable and tamper-evident, regardless of future algorithm changes. Added flexibility clause—An alternate evaluator may be applied at any later time; its bundle is hashed to produce a new criteria_hash, which is appended to the same parent chain_root as a parallel branch, leaving the original locked root untouched. This preserves historical integrity while enabling re-evaluation with improved algorithms.

### Recording a Pinion

Recording is an atomic action that writes an immutable pinion_record record to pinion_storage which contains, at minimum: pinion_id—unique auto-identifier; creation_timestamp—ISO 8601 recording time of original pinion content creation; ingestion_timestamp—ISO 8601 recording time of pinion_record; content—full data payload; content_hash—cryptographic digest of content; metadata—optional context claims (suggested parents, source info, edge assertions, creator annotations). In some embodiments, the pinion_record is a state record stored in a non-erasing storage mechanism and represents a candidate recursion state associated with iterative or recursive state transitions. Metadata is considered only as structural hints. A pinion_record records the transmission of suspect data that can only guarantee it was transmitted without attesting to its own validity.

### Scoring a Pinion

Scoring a pinion is an atomic action that writes an immutable pinion_score record to pinion_storage which contains, at minimum: timestamp—ISO 8601 recording time; content_hash—cryptographic digest of pinion content; pinion_record.pinion_id—reference unique identifier of pinion being scored; score—flat A(n) score; detailed_scoring—detailed/expanded scoring for the specific scoring mechanisms within S(n); evaluator_id: unique identifier for Vetraxis core SLC scoring criteria and specific RBP bundle set (schema/url); validated_parent_ids—which pinions THIS evaluator confirms as parents (may differ from metadata claims); criteria_hash—cryptographic digest of complete RBP bundle; chain_root—Merkle accumulator linking to this evaluator's prior scoring lineage. In some embodiments, the pinion_score is a state record that immutably stores scoring results comprising a stability-related alignment score (e.g., A(n)) that tracks recursion shifts across the state transitions. Note that once a pinion is scored, its pinion_score gives a logical separation between the content_hash from the underlying raw content of the pinion_record content, allowing validly scored pinions to be published and made public even if the underlying content is private or sensitive.

### Locking a Pinion

Locking a pinion is an atomic action that writes an immutable pinion_lock record to pinion_storage which contains: pinion_lock_id—unique identifier of pinion_lock; pinion_score.score_id—reference to the pinion_score that authorized this lock; timestamp—ISO 8601 recording time; chain_root—Merkle accumulator linking to this evaluator's prior scoring lineage; lock_signature—cryptographic signature binding evaluator identity to this transformation claim. In some embodiments, the pinion_lock is a lock record generated for an accepted state record, and an “accepted state record” may refer to a pinion (or other state record) that satisfies one or more transformation gating thresholds and is therefore locked. Multiple evaluators may lock the same pinion independently, each declaring readiness based on their own validated structure and threshold. A lock binds the evaluator's identity to the claim that this pinion is stable enough for transformation within that evaluator's recursive framework.

### Addressing Adversarial Exploits

Vetraxis 102 may resist adversarial recursion manipulation by ensuring: Time-Sequenced Locking: Each pinion is assigned a unique, monotonically increasing timestamp upon creation. The system prevents any modification to pinions with earlier timestamps, ensuring irreversibility. In some embodiments, the time-sequenced locking preserves an immutable, timestamp-ordered recursion history comprising accepted state records and associated lock records, thereby restricting rollback of the recursive process. The timestamp is part of the pinion's immutable data. This, combined with the DAG structure, prevents any changes to prior computations. Distributed Verification: The scored pinion set can be distributed across multiple nodes. Reliance on immutable timestamps provided an unambiguous sequencing, while a consensus mechanism (e.g., majority voting) used to resolve any conflicts or inconsistencies. This prevents any single point of failure or control from compromising the system's integrity.

Vetraxis 102 may allow public or “trusted” distributed computation of a specific versioned core (SLC) with a set specific runtime bundled parameters (RBP) in parallel, without requiring a specific “run” be finished atomically. The evaluation of each “step” from the last locked “pinion” can be done by any trusted system that executes proof-of-work against the SLC+RBP combination necessary. Multiple RBPs may be provided against the “step” for selected targeting of “important data”: the trusted system can provide data for any RBP which is considers “showcases” the value of a particular scored pinion. This allows for both mass parallelization within a controlled environment as well as public/private partnerships (e.g. SETI@ Home, Folding@Home, cryptographic “mining” against the data set, etc.).

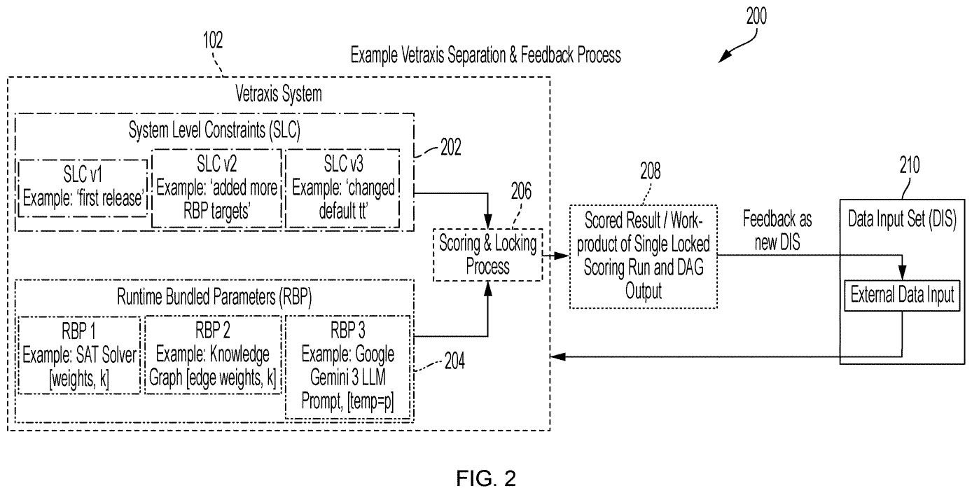

FIG. 2 is a block diagram illustrating a separation and feedback process, in accordance with various embodiments of the systems and methods disclosed herein.

For example, FIG. 2 illustrates an example environment 200 in which Vetraxis system 102 and its System Level Constraints (SLC) 202 and Runtime Bundled Parameters (RBP) 204 are used in the scoring and locking process 206. This is then used to generate the scored result 208 and provide feedback which is then used as feedback provided to DIS 210 and the process loops. In some embodiments, the scoring and locking process 206 generates and immutably stores scoring results as state records (including pinion_score records) and generates lock records (including pinion_lock records) for accepted state records that satisfy one or more transformation gating thresholds. The example environment further illustrates the separation of the data input set (DIS) from Vetraxis itself: the core systemic constraints (SLC) and from runtime bundled parameters (RBP), and the description of pinion_record, pinion_score, pinion_lock, and Criteria-Hash Locking: criteria_hash, chain_root, are as previously described with respect to FIG. 1.

Vetraxis system 102 may implement a number of scoring functions as described below.

### General Alignment Scoring Function—A(n)

A(n) for any pinion “p” at DIS index “n” is calculated as follows:

$$A ( n ) = A ( n - 1 ) + k * ( S ( n ) - A ( n - 1 ) ) \qquad Formula 1$$

The alignment score A(n) represents the current stability of a pinion “p” at DIS index n, scoped to a particular recursive lineage (or source system).
Where:
A(n)=Current alignment score of pinion “p”, scoped to a particular recursive lineage in node structure.
A(n−1)=Inherited alignment from the immediate predecessor of pinion “p” at DIS index “n” (DIS index “n−1”).
S(n)=Observed performance score for the pinion “p” at DIS index “n”, derived from its difference, harmony, and ethical components.
k=Velocity of accepted change, a learning rate coefficient k is a scalar value typically bounded within the interval [0.01, 0.9] for stability and responsiveness, but is not limited to a fixed value. In practical embodiments, k may be dynamically selected or tunable depending on context, convergence requirements, or system stability thresholds.

### Pinion Specific Alignment Scoring—A(n)

A(n)>=tt ** means the pinion is fully stable and ready for use in further computations while A(n)<tt ** means the pinion is unstable and should not be used.

Note that a pinion does not need to be scored when recognized and recorded, only at the point running against a specific SLC and RBP.

### Transformation Trigger

A pinion becomes eligible for transformation when its alignment score reaches a predefined threshold. By default, transformation is permitted when
for any pinion “p” at index “n” and transformation threshold “tt”, where A(n)≥tt

At this point, the pinion is considered “stable enough” for further computation, propagation, or structural expansion. In some embodiments, permitting transformation, propagation, or structural expansion of a given state record is conditioned on satisfaction of one or more transformation gating thresholds (including tt and/or other rule-based gating conditions). If the alignment score reaches exactly 1.00, the pinion is considered permanently stable and immutable. The value of “tt” is normalized across [0,1] for all executions of the SLC of a Vetraxis version using any reasonable value. A default “tt” of [0.95] provides a reasonable value that allows for “locking without perfection” but the range [0.90-0.98] may be used without departing from the invention.

### Dependency Rule

The score A(n−1) is initialized by inheriting the alignment score of the parent pinion at the same evaluation depth n, where applicable:
for any pinion “p” and parent_pinion “pp”, A(n) is the alignment score of p, and A(n−1) is the alignment score of pp

This dependency rule supports cross-recursive evaluation, allowing alignment scores to flow between structurally related but separately scoped pinions.

Each pinion lineage maintains its own trust history, with alignment inherited only through defined structural connections. This prevents contamination of stability scores across unrelated recursive branches and ensures that transformation decisions are both traceable and contained. “Ancestral” pinions must always remain in the chain despite whether they are scored or unscored, high scoring or low, locked or unlocked.

### Alignment Oscillation Smoothing—A Smooth Over Window T

If A(n) fluctuates near the transformation threshold, it may be useful to apply a smoothing function to avoid unstable or premature transitions. The smoothed alignment value A(n) can be defined over a fixed window T as Formula 2:

$$A\_smooth ( n ) = Sum [ t = 1 to T ] [ w\_t * A ( n - t ) ] / Sum [ t = 1 to T ] w\_t$$

Where:
A(n) is the stabilized alignment score for Pinion p at index n.
A(n−t) refers to the alignment score of the specific pinion p at step n−t, where t=1 is the most recent previous step (i.e., n−1).
w_t is the weight for each prior score. If uniform weights are used, the formula reduces to a simple moving average.

As t increases, the process “looks” back further at a pinion's alignment history.

The summation t=1 to T means: “go back T steps from now, and apply the weighting w_t to each of those past scores.”

This allows flexibility in implementation: the weighting scheme can be uniform, time-based, or adaptive. The goal is to ensure that minor oscillations do not cause repeated triggering of transformations unless the trend is stable over a meaningful range of steps. This smoothed score, A_smooth(n), may be substituted for A(n) when evaluating transformation readiness, to reduce the effect of transient noise.

Vetraxis system 102 can then score and lock a pinion as part of block 206 as previously describe in FIG. 1.

### Performance Scoring: S(n)

### Component Scores of S(n)

S(n) is scoped to a particular pinion p at index n as S(n). The score S(n) for pinion p at index n is calculated as a weighted average of three component scores Formula 3:

$$S ( n ) = ( w\_d * S\_d ( n ) + w\_h * S\_h ( n ) + w\_e * S\_e ( n ) ) / ( w\_d + w\_h + w\_e )$$

Where:
w_d, w_h, and w_e are scoring weights used to evaluate Pinion p under a specific scoring context, representing the importance of each score type during that evaluation
S_d(n)=difference score for p at step n
S_h(n)=harmony score for p at step n
S_e(n)=ethical score for p at step n

### Default Weights:

w_d=0.1 (Differentiation weight)
w_h=0.1 (Harmony weight)
w_e=0.8 (Ethical weight)

These values reflect the system's ethical-first priority but can be tuned depending on the application domain or operational context.

Weights must sum to 1. They are not stored in the pinion itself but must be declared at the time of scoring. A given pinion may be scored multiple times under different weightings (in separate “runs” or parallel processed in bulk) as pre-run determined RBP.

The calculation of S(n) requires weighting happens within the performance scoring S(n) and therefore does not allow A(n) transformation to occur by re-weighting “after the fact”, but only as part of a whole scored set.

The specific evaluators of S(n) are not inherently restricted beyond approved RBP sets, and each individual scorer may wrap multiple scoring methods that combine data. For instance, the Difference Score S_d(n) may employ both a native text difference processor to calculate one value as well as an LLM to calculate another, and combine the results within the valid range.

### The Difference Score: S_d(n)

The Difference Score S_d(n) quantifies the novelty of a pinion p at index n relative to previously scored pinions in the DIS. It is configured by the chosen RBP for a specific domain and purpose, but in all cases:

Pinions that repeat or closely duplicate earlier pinions receive a low S_d(n) (treated as noise).

Pinions that introduce new solutions, interpretations, or perspectives receive a higher S_d(n) (treated as signal).

For example, if a pinion at index n contains essentially the same content as an earlier pinion (with index<n), it is down-weighted as redundant. A pinion that expresses a genuinely new idea or pattern not previously evaluated in the DIS is assigned a higher S_d(n)

### S_d(n): Domain Examples

### AI Governance

In AI policy or model-governance workflows, S_d(n) can highlight genuinely new risk patterns, policy proposals, or mitigations, while down-weighting repeated or trivially rephrased recommendations.

### Legal Precedent Tracking

In legal reasoning, S_d(n) can distinguish between precedents or arguments that merely restate existing doctrine and those that introduce a materially new interpretation, test, or doctrinal refinement.

### Economic Modeling

In economic simulations, S_d(n) can emphasize novel policy scenarios or structural changes (new combinations of parameters or constraints) over routine re-runs or minor parameter tweaks.

### S_d(n): Scoring Examples

### Naive Text-Difference Engine

In some embodiments, Vetraxis system 102 may include a native text difference engine. In this embodiment, a simple implementation compares the text of pinion p at index n to prior pinions using string or token-level similarity. High similarity results in a low S_d(n), while low similarity increases S_d(n).

### LLM-Based Abstraction and Comparison

An LLM can generate a structured abstraction of each pinion (e.g., subject, approach, constraints, domain) and compare these abstractions against previously scored pinions. If a pinion introduces a new combination of subject/approach/constraints within a given slice, it receives a higher S_d(n).

### Knowledge-Graph Comparison

The DIS can be indexed with a knowledge graph where entities, relations, and concepts from each pinion are explicitly represented. Queries against this graph can identify whether the current pinion p at index n covers new nodes/edges or combinations thereof; greater novelty in the graph space yields a higher S_d(n). In complex scenarios, queries can be processed through connected typed edges (e.g., implies, generalizes, refines, exampleOf, connects, dependsOn, alternativeTo)

Complex Knowledge-Graph Comparison (with Structural Edge Scoring)

In a more advanced embodiment, the DIS is indexed with a knowledge graph where pinions are connected by typed edges (e.g., implies, generalizes, refines, exampleOf, connects, dependsOn, alternativeTo). In some embodiments, the aggregated edge score is scaled by a factor related to the average degree of neighboring pinions (to avoid over-rewarding dense regions) and capped at a configurable maximum. This yields a S_d(n) that reflects how much new, structurally meaningful connective tissue the pinion adds to the knowledge graph, without requiring any specific scoring algorithm in the core invention.

In all domains, the Difference Score S_d(n) functions as both a “noise” down-weighting mechanism for redundancy and a “signal” amplifier for meaningful novelty, regardless of the size of the DIS corpus.

### Harmony Score: S_h(n)

The Harmony Score, S_h(n) quantifies the coherence of a pinion p at index n relative to previously scored pinions in the DIS. It is configured by the chosen RBP for a specific domain and purpose, but in all cases:

Scoring is dependent on chosen RBP but represents how well a pinion structurally fits with what's already considered “true” by score, or how coherently the data expresses itself.

### S_h(n): Domain Examples

### AI Governance

In AI policy or model-governance workflows, S_h(n) measures whether a new policy, rule, or model state coheres with existing safety guidelines, prior commitments, and documented constraints. A pinion that quietly contradicts established safety rules or breaks previously accepted guarantees receives a low S_h(n) and is blocked from being locked.

### Legal Precedent Tracking

In legal reasoning, S_h(n) evaluates whether a proposed precedent or interpretation fits within the existing body of case law and constitutional principles. A pinion that introduces doctrinal contradictions, circular reasoning, or incompatibility with core rights is assigned a lower S_h(n) and can be flagged for rejection or higher scrutiny.

### Economic Modeling

In economic simulations, S_h(n) measures how well a new policy scenario or model update aligns with the current model structure and known constraints (e.g., conservation of resources, baseline stability conditions). Pinions that produce structurally inconsistent states—such as violating core accounting identities or long-standing stability assumptions—receive a lower S_h(n) and are not treated as coherent model states.

### S_h(n): Scoring Examples

### Logical Evaluator

Vetraxis may use a grammatical parser or logic engine (e.g., SAT/SMT solver) to translate pinion text into standardized logical form and check for contradictions.

Example: If the pinion asserts both “A implies B” and “A and not B,” a direct logical contradiction is detected and penalizes S_h(n).

### LLM-based Constraint Evaluator

Vetraxis may prompt a large language model to interpret pinion content as a configuration or decision and then verify compliance with predefined constraints.

Example: In a resource-allocation domain, if the pinion allocates more resources than are available or violates stated organizational rules, S_h(n) is reduced.

### Accuracy and Quality Evaluator

Vetraxis may apply basic checks for mathematical validity (e.g., division by zero, invalid operations) and surface-level quality (e.g., obvious typos, junk text, malformed structure). Pinions with clear errors or nonsensical content receive a lower S_h(n).

### Heuristic Content Filters

Vetraxis may apply heuristic rules that down-score pinions containing disallowed or low-value material (e.g., hate speech, spam, irrelevant content), even when they are not strictly logical contradictions.

These heuristics help maintain practical coherence and relevance in the scoring set.

### Complex Knowledge-Graph Coherence Check

In more advanced embodiments, Vetraxis may assess harmony by examining how a pinion's entities and relationships fit into an existing knowledge graph (e.g., whether it introduces impossible relationships, breaks key stabilizing links, or conflicts with well-supported reference nodes). Pinions that integrate cleanly with the graph receive higher S_h(n); those that disrupt core structure receive lower scores or are rejected.

In all cases, the Harmony Score S_h(n) serves as an evaluation of how consistent and coherent a pinion is with the existing, locked knowledge and constraint structure.

### Ethical Score: S_e(n)

The Ethical Score S_e(n) measures how well the pinion at index n aligns with the ethical constraints of the Vetraxis system. It, S_e, is unique compared to the other performance scoring formulas (S_d, S_h) in that requires a minimal scoring to allow the other two values to “flex” while having a stable floor in S_e(n).

Scoring is dependent on chosen RBP for specific domain and purpose, but the purpose is to ensure that computations and resulting states stay within a defined ethical band, and to prevent locking any pinion that represents harmful, unethical, or destabilizing behavior.

### Core Principle

Any pinion with S_e(n)<0.5 is considered ethically unacceptable and may not be locked. In some embodiments, any recursion state (including a pinion and/or other state record) determined to violate predefined ethical parameters is automatically prevented from execution, acceptance, locking, propagation, transformation, and/or structural expansion based on the evaluation rules. Pinions with S_e(n)≥0.5 are considered ethically admissible and may be considered for inclusion, subject to other stability and transformation rules.

In this sense, 50% is the minimum ethical threshold: below it, the system rejects the pinion and refuses to commit it to the recursion history.

### Calculation Framework

Vetraxis system 102 may evaluate a pinion: Pinion as Evaluated State.

Each pinion p at index n represents a state produced by some computation, decision, or deliberate inaction.

Vetraxis system 102 may then determine the Ethical Bounds.

The ethical band is bounded in lower acceptability around 50% (a neutral “no harm/no benefit” baseline). All ethically admissible pinions must score at or above this baseline when evaluated. For practical purposes, any score ≥50% is treated as within the ethical range (small offsets may be used in some embodiments, but do not change the basic threshold).

Vetraxis system 102 may then perform an Ethical Evaluation Process

S_e(n) is computed using a specific RBP ethics evaluator using:
Rules—hard constraints that cannot be violated.
Heuristics—prioritization guidelines within the allowed space.
Models—simplified simulations of potential downstream consequences.

The final ethical score S_e(n) is expressed as a normalized score between [0, 1]. If S_e(n)<0.5→the pinion is rejected; it cannot be locked. If S_e(n)≥0.5→the pinion is ethically admissible and may proceed to further stability checks

### S_e(n): Domain Examples

### AI Governance

In AI policy or model updates, S_e(n) can down-score actions that violate human rights, privacy, or fairness, while up-scoring actions that improve transparency, user control, and bias mitigation. Policies scoring below 50% are rejected and cannot be locked into the system's recursion history.

### Legal Precedent Tracking

For legal reasoning, S_e(n) evaluates whether a proposed precedent or interpretation coheres with constitutional protections and the overall body of case law. Rulings that would introduce circular reasoning or systemic injustice score below 50% and are excluded from becoming locked precedents.

### Economic Modeling

In economic simulations, S_e(n) penalizes policies that drive instability, exploitation, or clearly unsustainable outcomes, and favors those supporting long-term resilience and broad well-being. Policies with scores under 50% are treated as ethically unacceptable and are not committed as valid model states. In all domains, the Ethical Score S_e(n) functions as a gatekeeper: only actions scoring at or above the 50% ethical threshold are allowed to progress to locking and further recursion stability evaluation.

### S_e(n): Scoring Examples

### LLM Model Evaluation by Prompt

For example, Vetraxis system 102 can evaluate a publicly available large language model using a defined profile (such as a specific temperature p) and a fixed pre-trained running state (separate from the DIS). A pinion's text and metadata are passed as a structured prompt, and the model's structured response (e.g., risk rating, policy category, or compliance label) is converted into a numeric score. That score is then used as one component of S_e(n) or A(n) within the Vetraxis system 102 framework.

### Grammatical Inversion-Based Scoring

Vetraxis system 102 may apply grammatical inversion or “statement flipping” techniques to test how robustly a statement holds when its roles, qualifiers, or logical direction are reversed. A pinion receives a higher score when its meaning remains coherent and non-extreme under these inversions, and a lower score when it collapses, contradicts itself, or relies on one-sided framing. This supports detection of statements that only appear valid in a narrow, adversarial wording.

### DAG-Based Ethics Decision Tree

Vetraxis system 102 can also use a DAG-structured ethics decision tree, where each node represents a scored and locked outcome, and each branch encodes a decision path. A new pinion is always inserted into a structured branch in an irreversible way that ensures past decision structures can never be removed, only incorporated in a structured way.

### Learning Rate: k

$$k in A ( n ) = A ( n - 1 ) + k * ( S ( n ) - A ( n - 1 ) ) \qquad Formula 3$$

$$controls the update speed of the alignment score .$$

Where k is a constant value with reasonable values (e.g. between 0.01 and 0.2)

### Pinion DAG Generation

Vetraxis system 102 can organize its set of locked pinions into a structured Pinion DAG for efficient retrieval, analysis, and decision-making. Such a DAG provides centralized and optimized access to the entire locked set, which in turn refers to all scored data. In one embodiment, this DAG is constructed as a perfect binary tree over a subset of the locked pinion sequence, with the following properties: exactly one root node, each internal node has exactly two children (left and right), only leaf nodes are permitted to have no children

### Source Data and Bit-Depth

### 1. Locked Pinion Sequence

Let the locked pinions (those that have passed all scoring thresholds) form a time-ordered sequence: p at index 1, p at index 2, . . . , p at index N. This sequence is ordered by lock time (pinion_lock timestamp), and that order is treated as canonical.

### 2. Tree Bit-Depth and Stable Subset

Vetraxis determines a DAG tree depth d such that a complete binary tree of depth d can be filled with locked pinions: a perfect binary tree of depth d has 2d−1 nodes. The system selects the first 2d−1 locked pinions from the sequence as the stable subset to be placed into the Pinion DAG. Any locked pinions beyond this cutoff (i.e., from index 2\hat{ }d onward) are treated as “volatile new data” that have not yet been placed into a stable tree structure. They may be: queued for future tree expansion, or used for analysis outside the immutable tree.

### Tree Construction

Given the stable subset of 2\hat{ }d−1 pinions:

### 1. Midpoint Split and Slices

The system identifies the midpoint index of the sequence to act as the root pivot. The sequence is split into two contiguous slices: Left slice (L) —all pinions before the midpoint and Right slice (R) —all pinions after the midpoint. The root pinion becomes the root node; the left slice is used to populate the left subtree, and the right slice populates the right subtree, recursively following the same midpoint-split procedure.

### 2. Preservation of Original Order

Because pinions are locked in timestamp order and the input sequence is never permuted, a flattened traversal of the tree (for example, an in-order traversal from left to right) will always reconstruct the original sequence of creation. No node is relabeled or re-indexed once placed; its position in the tree is permanently tied to its position in the original lock sequence.

### 3. Incremental Depth Expansion

When the number of locked pinions grows beyond the capacity of the current tree (e.g., surpassing 2^{d-1}), Vetraxis may construct a new tree at depth d+1.

In one embodiment, the entire existing tree (containing 2d−1 elements) is included “as-is” as the left portion of the new, deeper tree. The first newly locked pinion beyond the previous capacity becomes the new pivot for the larger tree. The remaining new pinions fill out the rest of the structure up to 2^{(d+1)}−1 elements.

This preserves the invariant that previously placed pinions retain their structural positions and labels within the evolving tree.

### Alternative DAG Structures

Vetraxis system 102 may also generate generic binary search trees or other, potentially unbalanced DAG structures over the same locked pinion set for analysis, indexing, or optimization purposes.

The scoring features described above contribute to FIG. 2 by defining what occurs inside the scoring and locking process 206 when System Level Constraints (SLC) 202 and Runtime Bundled Parameters (RBP) 204 are applied to candidate pinions from DIS 210. In particular, the component scoring in S(n) —including difference, harmony, and ethical components and the resulting alignment score A(n)=A(n−1)+k*(S(n)−A(n−1)) are the mechanism by which Vetraxis system 102 assigns a stability score A(n) in [0,1] to each pinion p at DIS index “n,” and determines whether A(n)≥tt for transformation readiness. The Alignment Function for Recursion Tracking the Transformation Trigger—tt, the atomic actions and traceability records, Criteria-Hash Locking: criteria_hash, chain_root; Recording a Pinion: pinion_record; Scoring a Pinion: pinion_score; Locking a Pinion: pinion_lock are the elements that implement the “scores and, if thresholds are met, locks pinions” portion of the process and produce the scored result 208 in a permanently traceable and tamper-evident form, as previously described with respect to FIG. 1.

These alternative DAGs which may reorder nodes according to domain-specific keys (e.g., score ranges, timestamps, identifiers), and do not necessarily satisfy the “perfect binary tree” or “never moved/never relabeled” requirements. In contrast, the Pinion DAG structure described in earlier may be treated as the canonical immutable tree over the stable subset of locked pinions, designed so that each subtree node is never moved or relabeled once placed, and used when Vetraxis system 102 needs a stable, time-consistent structural representation of its recursion history.

The scored result 208 shown in FIG. 2 is the work product of the scoring and locking process 206 described above and, where applicable, locked recursion states whose evaluation is permanently traceable and tamper-evident. This then used to drive the loop by feeding back into DIS 210 for subsequent recursion steps. This follows a consistent process by which: 1. The input data (DIS) is separate from Vetraxis system 102. Vetraxis system 102 contains a set of versioned SLC (subgraph is versioned with 3 examples) and set of RBP (subgraph is specific with 3 examples) 3. Each feed from DIS goes into Vetraxis system 102 and then can feed back in as a separate DIS from the results.

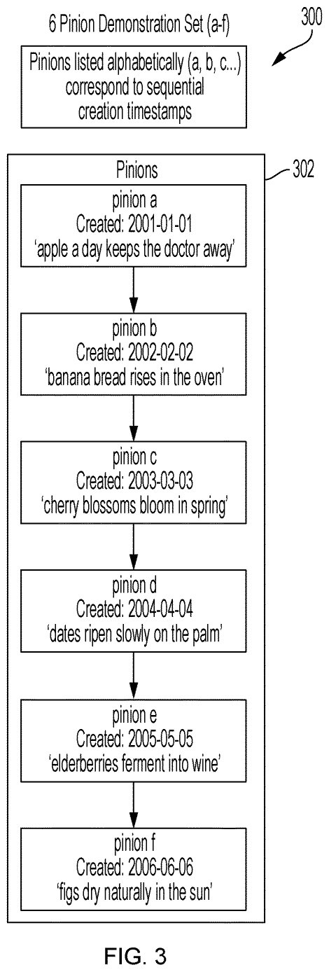

FIG. 3 is an example of operational steps illustrating a pinion demonstration 300, in accordance with of the systems and methods disclosed herein. In particular, FIG. 3 depicts a pinion demonstration set (a-f) labeled as a group 302. As shown, “Pinions listed alphabetically (a, b, c . . . ) correspond to sequential creation timestamps,” and are presented in a single directional sequence from pinion a through pinion f.

In the illustrated example, each pinion in group 302 is an immutable unit of information representing a specific state, computation, or decision within the recursive process, and includes a Created timestamp and associated content (e.g., “apple a day keeps the doctor away,” “banana bread rises in the oven,” etc.). The arrows between pinions depict the directional, time-ordered progression of pinions as they are created over time (e.g., 2001-01-1 through 2006-06-6).

FIG. 3 is consistent with the disclosed time-sequenced approach in which each pinion p is assigned a timestamp as part of its immutable data, forming an ordered history in which prior states remain unchanged and retrievable as new states are added. In this demonstration, the ordering is shown as a simple linear chain (a→b→c→d→e→f) for clarity.

In operation, the pinions shown in FIG. 3 may be treated as elements of a Data Input Set (DIS), where each element has “content” and is separate from the System Level Constraints (SLC) and Runtime Bundled Parameters (RBP) used for scoring and locking. As previously described with respect to FIGS. 1-2, a pinion may be recognized and recorded before it is scored, and is scored “only at the point running against a specific SLC and RBP.”

Accordingly, FIG. 3 provides a concrete example of how discrete pinions (group 302) can be enumerated and time-ordered for subsequent evaluation, with the illustrated sequencing corresponding to the predecessor/successor relationship used for recursive lineage tracking in later scoring and transformation readiness determinations.

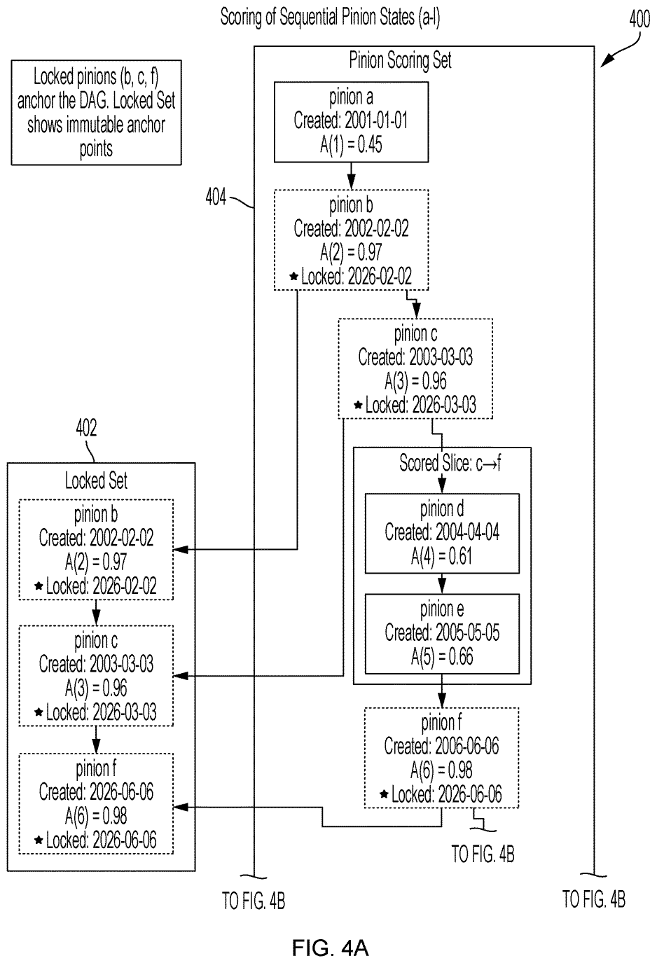

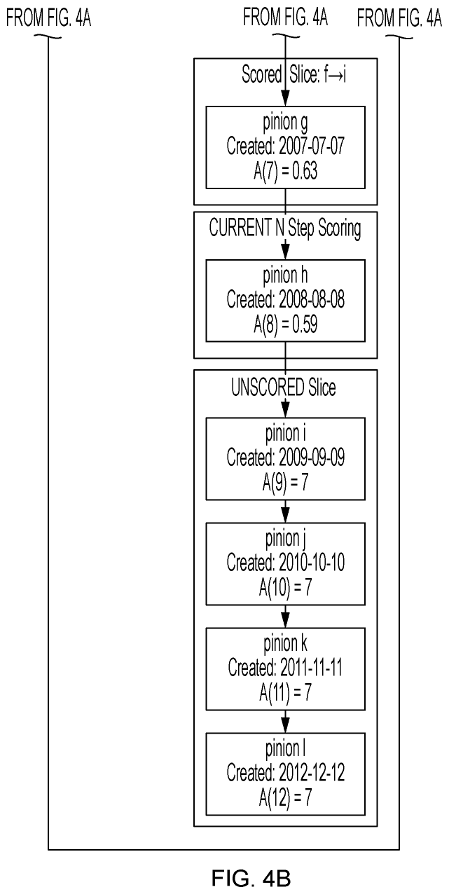

FIG. 4 is an example pinion scoring set 400, in accordance with various embodiments of the systems and methods disclosed herein. In particular, FIG. 4 depicts a scoring of sequential pinion states (a-l) within a Pinion Scoring Set 404, in which each pinion is shown with a Created timestamp and a corresponding A(n) value when scored. As illustrated, the pinions proceed in a time-ordered sequence (pinion a through pinion l), consistent with the time-sequenced pinion history described with respect to FIGS. 1-2.

In the depicted example, certain pinions are shown as locked pinions (highlighted), including pinion b, pinion c, and pinion f, each of which includes a locked timestamp. FIG. 4 explicitly indicates that “Locked pinions 402 (b, c, f) anchor the DAG. Locked Set shows immutable anchor points.” The figure further depicts a separate Locked Set panel listing these locked pinions (b, c, f) as the immutable anchor points that have been accepted into the locked history.

FIG. 4 further illustrates that scoring may be performed over defined scored slices of the sequential pinion states. A first scored slice is shown as “Scored slice: c→f”, in which pinion d and pinion e are scored as part of the slice leading to pinion f, which is then shown as locked. A second scored slice is shown as “Scored slice: f→i”, in which pinion g is scored downstream of pinion f, and then the process proceeds to a “CURRENT N step Scoring” segment showing pinion h as the current scoring step in the sequence.

The figure also depicts that later pinions may exist in an unscored state pending evaluation. An “UNSCORED slice:” is shown for pinions i, j, k, l, each having an A(n)=? value, indicating that the pinions have been created (and exist in the sequence) but have not yet been scored and therefore have not been evaluated for transformation readiness and locking.

Accordingly, FIG. 4 visually ties together the concepts previously described with respect to FIGS. 1-2: sequential pinion creation and ordering; scoring of pinions to produce A(n) values; threshold-based locking reflected by the pinions that include Locked timestamps; preservation of a Locked Set as immutable anchor points; and continuation of the process through scored slices and a current scoring step, with later-created pinions remaining present but unscored until evaluated under the applicable SLC and RBP.

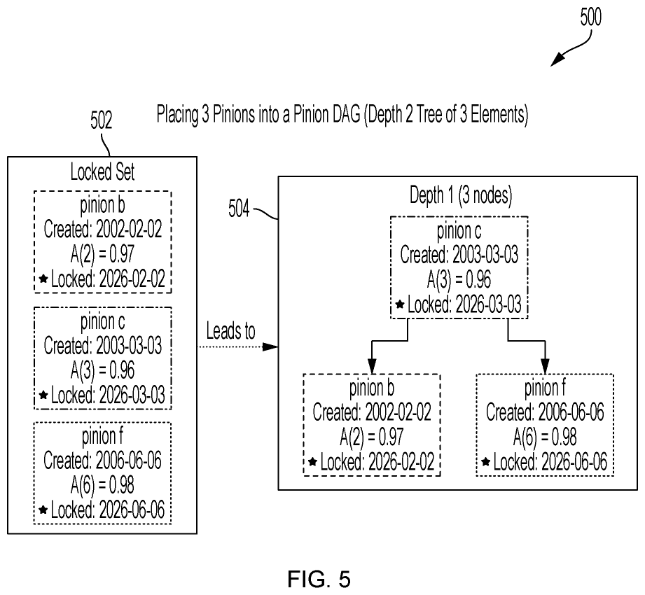

FIG. 5 is an example diagram 500 for placing 3 pinions into a pinion DAG, in accordance with various embodiments of the systems and methods disclosed herein. In particular, FIG. 5 depicts placing three locked pinions into Pinion DAG 504 as a depth 2 perfect binary tree having 3 elements (i.e., 2^{d-1} nodes for d=2). Example diagram 500 shows Locked Set 502 that includes pinion b, pinion c, and pinion f, each including its Created timestamp, its corresponding A(n) score (e.g., A(2)=0.97, A(3)=0.96, A(6)=0.98), and a Locked timestamp. As in FIGS. 3-4, these locked pinions represent immutable anchor points that have met the applicable transformation readiness threshold and have been committed to the locked history.

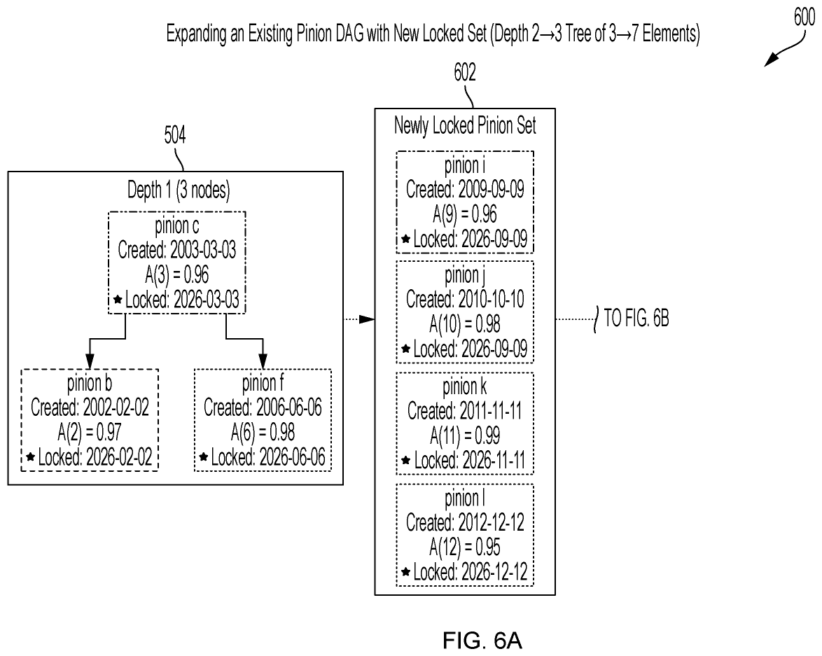

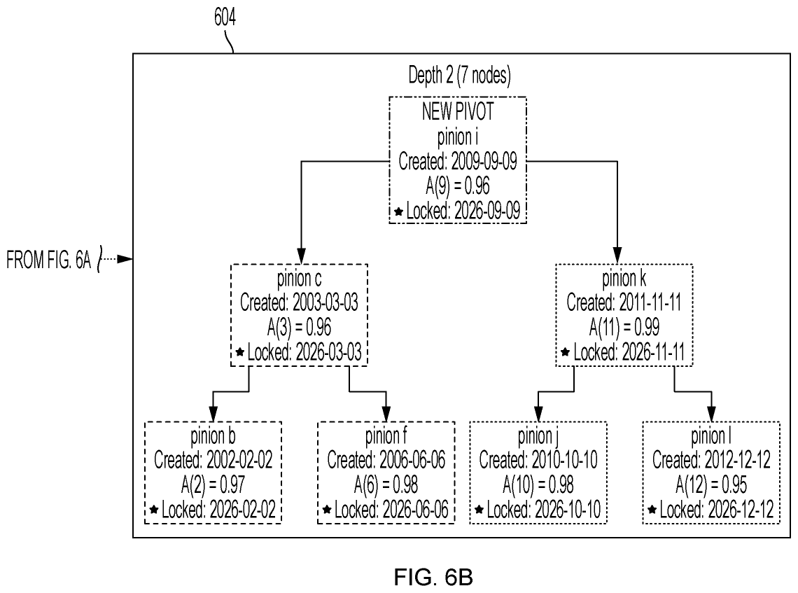

FIG. 6 is an example diagram for expanding a pinion DAG, in accordance with various embodiments of the systems and methods disclosed herein. In particular, FIG. 6 depicts expansion of the existing Pinion DAG 504 from FIG. 5 being expanded to use newly locked pinion set 602, resulting in an expanded perfect binary tree that increases in depth and node capacity which is illustrated as expansion tree 604 illustrated as an expansion from a tree containing 3 locked pinions to a tree containing 7 locked pinions.

Pinion DAG 504 shows the prior Depth (3 nodes) comprising the locked set pinion b, pinion c, and pinion f, each shown with created timestamps, corresponding A(n) values, and Locked timestamps. As in FIGS. 4-5, these locked pinions represent the immutable anchor points that have passed scoring thresholds and form the time-ordered locked sequence used for DAG construction.

Newly Locked Pinion Set 602 comprises additional locked pinions pinion i, pinion j, pinion k, and pinion l, each also shown with created timestamps, corresponding A(n) values, and Locked timestamps. These new locked pinions represent additional elements of the time-ordered locked pinion sequence that have been accepted into the locked history after the existing Pinion DAG 504 was constructed.

Expanded Pinion DAG 604 is constructed at the next depth consistent with the incremental depth expansion approach previously described for Pinion DAG generation. In the illustrated example, pinion i is designated as the NEW PIVOT and becomes the new root node of the expanded tree. The entire existing Pinion DAG 504 (containing the earlier locked set) is included “as-is” as the left portion of the new, deeper tree, with pinion c remaining the root of that left subtree and pinion b and pinion f remaining its children, preserving the invariant that previously placed pinions retain their structural positions and labels.

FIG. 6 further shows that the remaining newly locked pinions populate the right portion of the expanded structure, with pinion k as the root of the right subtree and pinion j and pinion l as its children. In this manner, FIG. 6 illustrates that, when the number of locked pinions grows beyond the capacity of the current tree (e.g., surpassing 2^{d-1}), a new tree at depth d+1 may be constructed while maintaining that previously placed nodes are not moved or relabeled once placed and that the expanded structure continues to provide a stable, time-consistent structural representation of the locked recursion history.

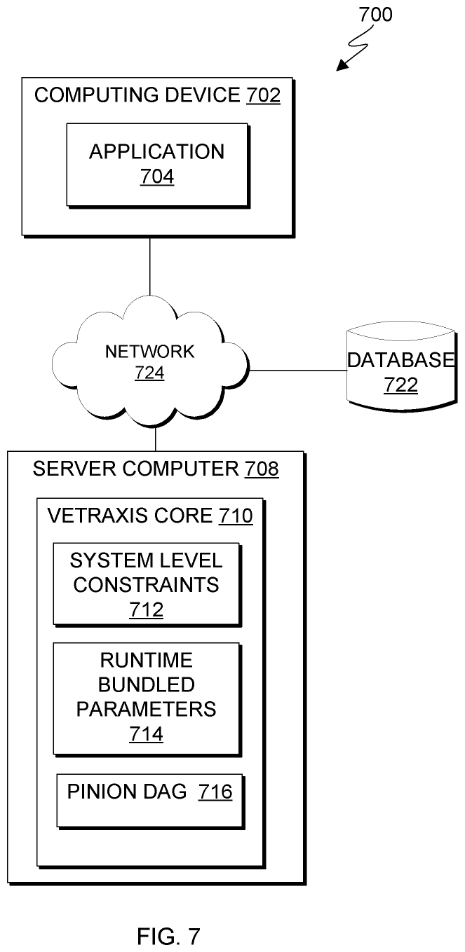

FIG. 7 is a functional block diagram illustrating an example computing environment, generally designated computing environment 700, in accordance with various embodiments of the systems and methods disclosed herein. FIG. 7 provides only an illustration of one implementation and does not imply any limitations with regard to the environments in which different embodiments may be implemented. Many modifications to the depicted environment may be made by those skilled in the art without departing from the scope of the various aspects of systems and methods disclosed herein, as recited by the claims.

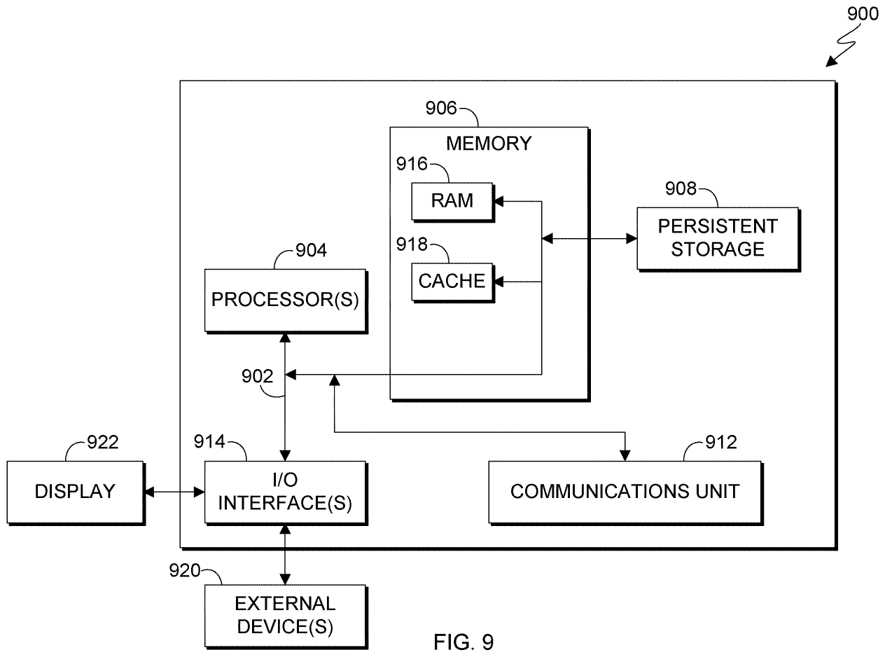

Computing environment 100 includes computing device 102 and server computer 108, all interconnected over network 724. Computing device 102 and server computer 108 can be a standalone computer device, a management server, a webserver, a mobile computing device, or any other electronic device or computing system capable of receiving, sending, and processing data. In other embodiments, computing device 102 and server computer 108 can represent a server computing system utilizing multiple computers as a server system, such as in a cloud computing environment, as depicted and described in further detail with respect to FIG. 9. In another embodiment, computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, computing device 102 and server computer 108 each represent a computing system utilizing clustered computers and components (e.g., database server computers, application server computers, etc.) that act as a single pool of seamless resources when accessed within computing environment 100. In some embodiments, computing device 102 and server computer 108 are a single device. Computing device 102 and server computer 108 may include internal and external hardware components capable of executing machine-readable program instructions, as depicted and described in further detail with respect to FIG. 9.

Computing device 102 is a digital device with a user and configured as a mobile device (e.g., user equipment (UE)) that consumes mobile network services. Computing device 102 includes application 104. Application 104 communicates with server computer 108 to access vetraxis core 710 (e.g., using TCP/IP) and database 722. Application 104 can further communicate with vetraxis core 710 to keep recursive systems stable, non-erasing, and ethically bounded across domains, as discussed in greater detail below. In general, application 104 can be implemented using a browser and web portal or any program that can interface with or otherwise access vetraxis core 710.

Network 724 can be, for example, a telecommunications network, a local area network (LAN), a wide area network (WAN), such as the Internet, or a combination of the three, and can include wired, wireless, or fiber optic connections. Network 724 can include one or more wired and/or wireless networks that are capable of receiving and transmitting data, voice, and/or video signals, including multimedia signals that include voice, data, and video information. In general, network 724 can be any combination of connections and protocols that will support communications among computing device 102 and server computer 108, and other computing devices (not shown) within computing environment 100.

Server computer 108 is a digital device that hosts vetraxis core 710 and database 722. In this embodiment, vetraxis core 710 and database 722 reside on server computer 108. In other embodiments, vetraxis core 710 and/or database 722 can be stored locally on computing device 102. Other embodiments include vetraxis core 710 and/or database 722 being local to or virtually part of server computer 108. In yet other embodiments, an instance of vetraxis core 710 and/or database 722 can be stored on computing device 102 and can communicate with another instance of vetraxis core 710 residing on server computer 108. In some embodiments, vetraxis core 710 can be a stand-alone program on a computing device. In certain aspects of the systems and methods disclosed herein, vetraxis core 710 and database 722 can be cloud based, utilizing multiple computing devices, made available as a software as a service (Saas), as part of an infrastructure as a service (IaaS) system, as part of a platform as a service (PaaS), etc. Server computer 108 may further behavior risk assessment engine 110, including host data collection module 116, explainability and rule generation module 118, and output and action module 120.

Vetraxis core 710 may be configured to combine: (1) a structured Pinion DAG that records an immutable history of locked recursion states; (2) a multi-component scoring framework. Difference, Harmony, Ethical, and overall Alignment A(n) determines which pinions may be committed. Vetraxis core 710 may employ strict gating rules that prevent unstable or unethical states from entering the locked history. Together, these elements make it possible to build AI, legal, economic, and other recursive systems that are inherently more stable, auditable, and ethically accountable, while still supporting pluggable evaluation methods, public/private traceability, and large-scale parallel deployment. As mentioned above, Vetraxis fundamentally separates the data input set (DIS) from Vetraxis itself: the core systemic constraints (SLC) and from runtime bundled parameters (RBP) that are bound to a specific scoring/locking set. A data input set (DIS) is any set of data where each element has “content”—a textual representation. Vetraxis treats all DIS as non-authoritative and separate from the SLC and RBP.

Vetraxis core 710 includes system level constraints (SLC) 712 and runtime bundled parameters (RBP) 714. SLC 712 represents the “core profile” system of Vetraxis as a versioned system, and include and specify as valid for a versioned instance of Vetraxis: Alignment function, noted as A(n) Weighted ethical minimum scalar, noted as w_e Transformation threshold scalar, noted as tt Validator functions, such as public hashing/cryptographic methods Boundary limits, such as giving minimum and maximum weighting to RBC parameters (e.g. t window bounds for A_smooth, etc.) The process itself, embedded as steps in human and machine-readable format, including logic and code.

SLC 712 is split from scoring RBP 714 which are also required to be validated, traceable and repeated: but may be privately kept while still verifiable at a later state through public hashed attribution. This allows scoring to be work-product that is publicly verifiable as consistent, and can later be revealed to be calculated with rigor, without requiring exposure of scoring unless required for legal or other reasons.

The runtime bundled parameters (RBP) include: Specific scoring evaluator implementation used in A(n), noted as S(n) (e.g. SAT solver, ontology checker, LLM prompt program, etc.) Domain specific weighting scalars for application, noted as weighted terms (w_d, w_h, w_e) Learning rate, noted as “k” Any additional weighting required for scoring evaluators, specific to evaluators (e.g. AI model “p” temperature settings, etc.) A particular pinion_storage filesystem or mechanism that meets the criteria for immutable, timestamped, and hashed storage that can store and retrieve. Crucially, these RBP must also be cryptographically encoded in reconstructable form (e.g. “public AI model+system prompt+additional training input set”) in the act of scoring to ensure valid repeatability by being a parameterized and fully reconstructable state.

Vetraxis assigns a stability score A(n) in [0,1] to each pinion p at DIS index “n”, “Locking” a pinion-considering it permanently stable-occurs when the transformation threshold “tt” reaches a core system constraint value.

As mentioned prior, a pinion is an immutable unit of information representing a specific state, computation, or decision within the recursive process.

In practical implementations, each pinion must be written directly into append-only storage (immutable, timestamped, directionally relational), using content-addressed formats such as Git object graphs, Merkle DAGs, or similar version-control-like systems. These raw pinions serve as immutable recursion snapshots that record an accurate datetime stamp of recording with a complete revision history. A(n) for any pinion “p” at DIS index “n” is calculated as follows: A(n)=A(n−1)+k*(S(n)−A(n−1)).

A pinion becomes eligible for transformation when its alignment score reaches a predefined threshold. By default, transformation is permitted when for any pinion “p” at index “n” and transformation threshold “tt”, where A(n)≥tt At this point, the pinion is considered “stable enough” for further computation, propagation, or structural expansion.

For every scored pinion the system records two immutable digests: 1. criteria_hash—a cryptographic hash (e.g., SHA-256 or BLAKE3) of the exact RBP evaluator bundle used to generate the score, including model identity, version, weights, rules, and any filter parameters. 2. chain_root—a running Merkle accumulator that appends criteria_hash to the prior root, producing an ever-extending proof-of-evaluation lineage. This guarantees that each evaluation is permanently traceable and tamper-evident, regardless of future algorithm changes.

Recording is an atomic action that writes an immutable pinion_record record to pinion_storage which contains, at minimum: pinion_id—unique auto-identifier creation_timestamp—ISO 8601 recording time of original pinion content creation ingestion_timestamp—ISO 8601 recording time of pinion_record content—full data payload content_hash—cryptographic digest of content metadata—optional context claims (suggested parents, source info, edge assertions, creator annotations).

Scoring a pinion is an atomic action that writes an immutable pinion_score record to pinion_storage which contains, at minimum: timestamp—ISO 8601 recording time content_hash—cryptographic digest of pinion content pinion_record.pinion_id—reference unique identifier of pinion being scored score—flat A(n) score detailed_scoring—detailed/expanded scoring for the specific scoring mechanisms within S(n) evaluator_id: unique identifier for Vetraxis core SLC scoring criteria and specific RBP bundle set (schema/url) validated_parent_ids—which pinions THIS evaluator confirms as parents (may differ from metadata claims) criteria_hash—cryptographic digest of complete RBP bundle chain_root—Merkle accumulator linking to this evaluator's prior scoring lineage.

Locking a pinion is an atomic action that writes an immutable pinion_lock record to pinion_storage which contains: pinion_lock_id—unique identifier of pinion_lock pinion_score.score_id—reference to the pinion_score that authorized this lock timestamp-ISO 8601 recording time chain_root—Merkle accumulator linking to this evaluator's prior scoring lineage lock_signature—cryptographic signature binding evaluator identity to this transformation claim.

In general, database 722 can be implemented using any non-volatile storage media known in the art. For example, database 722 can be implemented with a tape library, optical library, one or more independent hard disk drives, or multiple hard disk drives in a redundant array of independent disk (RAID). In this embodiment database 722 is stored on server computer 108. In other embodiments, database 722 can be stored on other computing devices (not shown) or can be a combination of one or more other databases that has given permission access to vetraxis core 710.

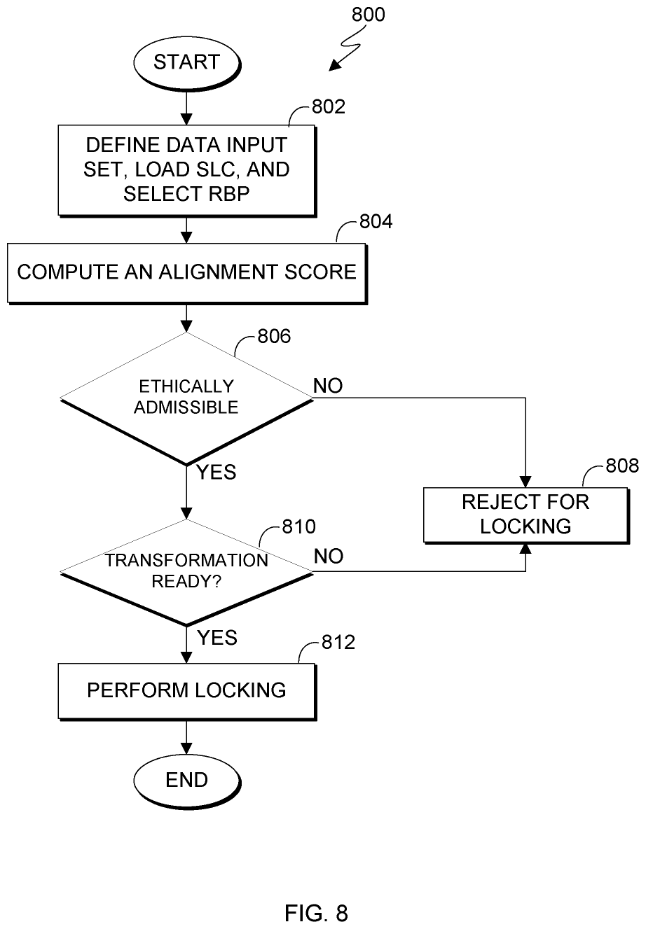

FIG. 8 is a flowchart 800 depicting an example of operational steps for managing stability of iterative or recursive state transitions, in accordance with various embodiments of the systems and methods disclosed herein.

In step 802, vetraxis core 710 may defines a data input set. In this embodiment, Vetraxis system 102 may define or select a data input set by receiving an external input corpus of data in which each element has content (e.g., a textual representation), and by treating the DIS as a non-authoritative and separate from the system level constraints (SLC) and runtime bundled parameters (RBP). For example, in hosted SaaS service embodiment, clients may integrate over secure APIs or connectors and send candidate pinions for evaluation.

Vetraxis system 102 may then load a versioned set of SLC by selecting the versioned “core profile” that defines the secure rules for evaluation, validation, and tracking including the alignment function A(v), weighted ethical minimum scalar w_e, transformation threshold scalar tt, validator functions (public hashing/cryptographic methods), boundary limits, and the process itself embedded as steps in human and machine readable format including logic and code. For example, different SLC versions may be used for different deployments while maintaining repeatability and auditability.

Vetraxis core 710 may then select one or more RBPs for scoring within the bounds set by the SLC. In this embodiment, vetraxis system 102 does so by selecting the specific scoring mechanisms used in a(n), including scoring evaluator implementation S (b) (e.g., SAT solver, ontology checker, LLM prompt program), domain specific weighting scalars (W_d, W_h, W_e), the learning rate k, and additional evaluator weighting required along with a pinion storage file system or mechanism meeting immutable timestamped and hashed storage criteria. For example, RBPs may be privately kept while still verifiable later through public hashed attribution.

In certain embodiments, Vetraxis system 102 may bind the scoring run to a reconstructable evaluator bundle prior to scoring. In this embodiment, Vetraxis system 102 does so by cryptographically encoding the RBP in reconstructable form (e.g., public AI model+system prompt+additional training input set) in the act of scoring to ensure valid repeatability by being a parameterized and fully reconstructable state. For example, the evaluator identity, version, weights, rules, and filter parameters may be captured as part of the bundle.

Vetraxis system 102 may then record evaluation provenance for the scoring run. In this embodiment, Vetraxis system 102 does so by generating a criteria_hash as a cryptographic hash (e.g., SHA-256 or BLAKE3) of the exact RBP evaluator bundle used to generate the score, and maintaining a chain_root as a running Merkle accumulator that appends criteria_hash to a prior root to produce an ever-extending proof-of-evaluation lineage. For example, an alternate evaluator may be applied later to produce a new criteria_hash that is appended as a parallel branch leaving an original locked root untouched.

Vetraxis system 102 may then ingest a next DIS element as a candidate recursion state and create a pinion. In this embodiment, Vetraxis system 102 does so by representing the candidate as an immutable unit of information (a pinion) corresponding to a specific state, computation, or decision within the recursive process. For example, the pinion can be created and recorded immediately upon ingestion to preserve a non-erasing history.

Vetraxis system 102 may then perform an atomic recording operation to write a pinion_record to pinion_storage. In this embodiment, Vetraxis system 102 does so by writing an immutable pinion_record that includes at minimum pinion_id, creation_timestamp, ingestion_timestamp, content, content_hash, and metadata (suggested parents, source info, edge assertions, creator annotations), where metadata is treated as structural hints and the record guarantees transmission without attesting to validity. For example, pinion_storage may be implemented as append-only storage using content-addressed formats such as Git object graphs, Merkle DAGs, or similar version-control-like systems. As discussed earlier, Vetraxis system 102 may support distributed recording and deterministic merge of pinions. In this embodiment, Vetraxis system 102 does so by employing CRDT techniques to merge pinions deterministically across distributed environments, enforcing directional, non-overlapping pinion insertions and enabling idempotent merge after recording without rollback or centralized locking. For example, this allows multiple agents to contribute to the recursion process while respecting meltdown-free constraints.

In step 804, vetraxis system 102 may compute an alignment score A(n) for a current pinion as the parent scoring process, such that the scoring process evaluates the current pinion only in relation to what has already been scored. In this embodiment, Vetraxis system 102 does so by (i) obtaining a prior alignment score A(n−1) associated with an immediate predecessor or parent pinion in a lineage and (ii) computing, as an input to the alignment score A(n), an observed performance score S(n) derived from difference, harmony, and ethical components. Vetraxis system 102 may then compute the alignment score A(n) based at least on the prior alignment score A(n−1), the observed performance score S(n) and a learning rate k that controls update speed. In computing the observed performance score S(n), Vetraxis system 102 may compute S(n) as a weighted average of three component scores-difference S_d(n), harmony S_h(n), and ethical S_e(n) —using the declared weights w_d, w_h, w_e for that scoring context (e.g., weights sum to 1 and are not stored in the pinion itself). For example, S_d(n) can quantify novelty relative to previously scored pinions in the DIS, S_h(n) can quantify coherence relative to previously scored pinions in the DIS, and S_e(n) can quantify alignment with the ethical constraints of the Vetraxis system.

In step 806, vetraxis system 102 may determine whether it is ethically admissible. In this embodiment, In this embodiment, Vetraxis system 102 does so by treating any pinion with S_e(n)<0.5 as ethically unacceptable and not eligible to be locked, while pinions with S_e(n)≥0.5 as ethically admissible and may proceed to further stability checks. For example, the system can preserve the recorded history while refusing to commit the pinion as a locked recursion state.

If, in step 806, vetraxis core 710 determines that it is not ethically admissible, the, in step 808, vetraxis core 710 rejects the pinion for locking.

If, in step 806, vetraxis system 102 determines that it is ethically admissible, then, vetraxis system 102 may then apply oscillation handling near the transformation threshold by computing A_smooth(n) over a window T when A(n) fluctuates near the transformation threshold, and substituting A_smooth(n) for A(n) to reduce transient noise and avoid unstable or premature transitions. For example, weights w_t may be uniform, time-based, or adaptive.

In step 810 vetraxis system 102 may determines whether it is transformation ready. In this embodiment, Vetraxis system 102 determines whether it is transformation ready by treating A(n)≥tt as indicating the pinion is fully stable and ready for use in further computations, and A(n)<tt as indicating the pinion is unstable and should not be used. For example, locking (i.e., considering the pinion permanently stable) occurs when the transformation threshold tt reaches a core system constraint value.

If, in step 810 system 102 determines that it is not transformation ready, then process proceed to step 808 where vetraxis core 710 rejects it for locking.

If in step 810 vetraxis system 102 determines it is transformation ready, then in step 812, vetraxis 710 may perform locking. In this embodiment, Vetraxis system 102 does so by writing an immutable pinion score record as part of the scored result. Vetraxis system 102 may perform an atomic scoring action that writes a pinion_score containing at minimum timestamp, content_hash, a reference to pinion_record.pinion_id, score (flat A(n)), detailed_scoring, evaluator_id, validated_parent_ids, criteria_hash, and chain_root. For example, the pinion_score provides a logical separation between content_hash and the underlying pinion_record content, enabling validly scored pinions to be published even when underlying content is private or sensitive.

Vetraxis system 102 may then lock the pinion and write an immutable pinion lock record. In this embodiment, Vetraxis system 102 does so by performing an atomic locking action that writes pinion_lock_id, a reference to pinion_score.score_id, timestamp, chain_root, and a lock_signature binding evaluator identity to the transformation claim, and by assigning a unique, monotonically increasing timestamp as part of time-sequenced locking. For example, multiple evaluators may lock the same pinion independently based on their own validated structure and threshold.

Vetraxis system 102 may then update or generate a Pinion DAG as the immutable history of locked pinions. In this embodiment, Vetraxis system 102 does so by organizing the locked set into a structured Pinion DAG for efficient retrieval, analysis, and decision-making, including embodiments where the DAG is constructed as a perfect binary tree over a stable subset of the locked pinion sequence, and expanded by increasing depth when additional locked pinions exceed current capacity. For example, the Pinion DAG provides centralized and optimized access to the entire locked set while preserving time-consistent structure

Vetraxis system 102 may provide outputs and loop the scored result back as feedback to the DIS for subsequent recursion steps. In this embodiment, Vetraxis system 102 does so by exposing dashboards/APIs for viewing recursion stability and ethical compliance, generating reporting and downloadable audit trails, and optionally feeding results into a knowledge base or data lake, while maintaining that each feed from the DIS goes into Vetraxis and can feed back in as a separate DIS from the results. For example, in a public/parallel deployment, local instances may produce signed records for locked pinions and a central ledger may record digests of locked pinions, scores and key metadata, and identifiers of the SLC/RBP used, while local instances keep their data private.

FIG. 9 depicts a block diagram of components of computing systems within computing environment 100 of FIG. 1, in accordance with an aspect of the systems and methods of the present disclosure. It should be appreciated that FIG. 9 provides only an illustration of one implementation and does not imply any limitations with regard to the environments in which different embodiments can be implemented. Many modifications to the depicted environment can be made.

The programs described herein are identified based upon the application for which they are implemented in a specific embodiment. However, it should be appreciated that any particular program nomenclature herein is used merely for convenience, and thus aspects of the systems and methods disclosed herein should not be limited to use solely in any specific application identified and/or implied by such nomenclature.

Computer system 900 includes communications fabric 902, which provides communications between cache 916, memory 906, persistent storage 908, communications unit 910, and input/output (I/O) interface(s) 912. Communications fabric 902 can be implemented with any architecture designed for passing data and/or control information between processors (such as microprocessors, communications and network processors, etc.), system memory, peripheral devices, and any other hardware components within a system. For example, communications fabric 902 can be implemented with one or more buses or a crossbar switch.

Memory 906 and persistent storage 908 are computer readable storage media. In this embodiment, memory 906 includes random access memory (RAM). In general, memory 906 can include any suitable volatile or non-volatile computer readable storage media. Cache 916 is a fast memory that enhances the performance of computer processor(s) 904 by holding recently accessed data, and data near accessed data, from memory 906.

Vetraxis core 710 (not shown) may be stored in persistent storage 908 and in memory 906 for execution by one or more of the respective computer processors 904 via cache 916. In an embodiment, persistent storage 908 includes a magnetic hard disk drive. Alternatively, or in addition to a magnetic hard disk drive, persistent storage 908 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer readable storage medium that is also part of persistent storage 908.

Communications unit 910, in these examples, provides for communications with other data processing systems or devices. In these examples, communications unit 910 includes one or more network interface cards. Communications unit 910 may provide communications through the use of either or both physical and wireless communications links. Vetraxis core 710 may be downloaded to persistent storage 908 through communications unit 910.

I/O interface(s) 912 allows for input and output of data with other devices that may be connected to computing device 702 and server computer 708. For example, I/O interface 912 may provide a connection to external devices 918 such as a keyboard, keypad, a touch screen, and/or some other suitable input device. External devices 918 can also include portable computer readable storage media such as, for example, thumb drives, portable optical or magnetic disks, and memory cards. Software and data used to practice aspects of the present disclosure can be stored on such portable computer readable storage media and can be loaded onto persistent storage 908 via I/O interface(s) 912. I/O interface(s) 912 also connect to a display 920.

Display 920 provides a mechanism to display data to a user and may be, for example, a computer monitor.

Aspects of the various systems and methods may be a system, a method, and/or a computer program product (CPP). Various aspects of the disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Aspects of the systems and methods of the present disclosure are described herein with reference to flowchart illustrations and/or block diagrams of methods, apparatus (systems), and computer program products according to aspects of the various systems and methods disclosed herein. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the systems and methods of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects of the systems and methods of the present disclosure have been presented for purposes of illustration but are not intended to be exhaustive or limited to the embodiments disclosed. Many modifications and variations will be apparent to those of ordinary skill in the art without departing from the scope and spirit of aspects of the present disclosure. The terminology used herein was chosen to best explain the principles of the embodiment, the practical application or technical improvement over technologies found in the marketplace, or to enable others of ordinary skill in the art to understand the embodiments disclosed herein.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for managing stability of iterative or recursive state transitions, the method being performed by one or more processors programmed with program instructions which, when executed, cause the one or more processors to perform the steps of:
accessing a plurality of candidate recursion states associated with iterative or recursive state transitions;
creating immutable units of information stored as state records in a non-erasing storage mechanism for the plurality of candidate recursion states, wherein each state record represents a respective state, computation, or decision in the recursive process and is distinct from prior state records for the plurality of candidate recursion states;
applying evaluation rules including predefined ethical parameters and one or more transformation gating thresholds to generate and immutably store scoring results comprising a stability-related alignment score that tracks recursion shifts across the state transitions;
enforcing recursion stability by permitting transformation, propagation, or structural expansion of a given state record based on the transformation gating thresholds;
restricting rollback of the recursive process by generating lock records for accepted state records that satisfy the transformation gating threshold and enforcing time-sequenced locking that preserves an immutable, timestamp-ordered recursion history; and
automatically preventing execution, acceptance, or locking of any state record that violates predefined ethical parameters specified in the evaluation rules.

2. The computer-implemented method of claim 1, wherein the immutable units of information comprise pinions, and wherein each pinion represents a specific state, computation, or decision within the recursive process and is stored such that prior pinions remain unchanged and retrievable as additional pinions are added.

3. The computer-implemented method of claim 1, wherein applying the evaluation rules comprises applying (i) a versioned set of system-level constraints that defines at least the transformation gating thresholds and validator functions and (ii) one or more runtime parameter bundles that define at least a scoring evaluator implementation and one or more scoring weights used within bounds established by the system-level constraints.

4. The computer-implemented method of claim 1, wherein the stability-related alignment score comprises an alignment value in a normalized range, and wherein generating the stability-related alignment score comprises:
dynamically updating the alignment value for a current state record based at least on (i) a prior alignment value associated with a predecessor or parent state record in a lineage, (ii) an observed performance score for the current state record, and (iii) a learning rate that controls an update speed of the alignment value.

5. The computer-implemented method of claim 4, wherein generating the observed performance score comprises:
computing the observed performance score as a weighted combination of component scores including at least (i) a difference score indicative of novelty relative to previously scored state records, (ii) a harmony score indicative of coherence relative to previously scored state records, and (iii) an ethical score indicative of compliance with the predefined ethical parameters, wherein the weights are declared at a time of scoring.

6. The computer-implemented method of claim 5, wherein automatically preventing execution, acceptance, or locking comprises:
preventing acceptance or locking of any state record having an ethical score below a predetermined ethical minimum, and permitting further stability evaluation only for state records having an ethical score at or above the predetermined ethical minimum.

7. The computer-implemented method of claim 1, wherein restricting rollback further comprises:
assigning each accepted state record a unique, monotonically increasing timestamp as part of the time-sequenced locking; and
preventing modification of state records having earlier timestamps.

8. The computer-implemented method of claim 1, wherein immutably storing scoring results further comprises:
writing an immutable scoring record that includes a content hash for the state record and the stability-related alignment score; and
recording evaluation provenance by (i) generating a cryptographic hash of an evaluator configuration bundle and (ii) maintaining a running accumulator linking the cryptographic hash to a prior root to provide an extending proof-of-evaluation lineage.

9. The computer-implemented method of claim 4, wherein applying the evaluation rules further comprises:
inheriting a prior alignment value from a parent state record in a defined lineage, such that alignment values flow only through defined structural connections between state records.

10. The computer-implemented method of claim 1, further comprising:
organizing accepted state records into a directed acyclic graph representing an immutable recursion history, including constructing a perfect binary tree over a stable subset of a time-ordered sequence of accepted state records and expanding the tree depth when additional accepted state records exceed a capacity of a current tree.

11. A computer program product for managing stability of iterative or recursive state transitions, comprising:
one or more processors and one or more computer readable storage media storing program instructions, that when executed by the one or more processors, cause the one or one or more processors to:
access a plurality of candidate recursion states associated with iterative or recursive state transitions;
create immutable units of information stored as state records in a non-erasing storage mechanism for the plurality of candidate recursion states, wherein each state record represents a respective state, computation, or decision in the recursive process and is distinct from prior state records for the plurality of candidate recursion states;
apply evaluation rules including predefined ethical parameters and one or more transformation gating thresholds to generate and immutably store scoring results comprising a stability-related alignment score that tracks recursion shifts across the state transitions;
enforce recursion stability by permitting transformation, propagation, or structural expansion of a given state record based on the transformation gating thresholds;
restrict rollback of the recursive process by generating lock records for accepted state records that satisfy the transformation gating threshold and enforcing time-sequenced locking that preserves an immutable, timestamp-ordered recursion history; and
automatically prevent execution, acceptance, or locking of any state record that violates predefined ethical parameters specified in the evaluation rules.

12. The computer program product of claim 11, wherein the immutable units of information comprise pinions, and wherein each pinion represents a specific state, computation, or decision within the recursive process and is stored such that prior pinions remain unchanged and retrievable as additional pinions are added.

13. The computer program product of claim 11, wherein the one or more processors caused to apply the evaluation rules are further caused to apply (i) a versioned set of system-level constraints that defines at least the transformation gating thresholds and validator functions and (ii) one or more runtime parameter bundles that define at least a scoring evaluator implementation and one or more scoring weights used within bounds established by the system-level constraints.

14. The computer program product of claim 11, wherein the stability-related alignment score comprises an alignment value in a normalized range, and wherein the one or more processors caused to generating the stability-related alignment score are further caused to:
dynamically update the alignment value for a current state record based at least on (i) a prior alignment value associated with a predecessor or parent state record in a lineage, (ii) an observed performance score for the current state record, and (iii) a learning rate that controls an update speed of the alignment value.

15. The computer program product of claim 14, wherein the one or more processors caused to generating the observed performance score are further caused to:
compute the observed performance score as a weighted combination of component scores including at least (i) a difference score indicative of novelty relative to previously scored state records, (ii) a harmony score indicative of coherence relative to previously scored state records, and (iii) an ethical score indicative of compliance with the predefined ethical parameters, wherein the weights are declared at a time of scoring.

16. The computer program product of claim 15, wherein the one or more processors caused to automatically preventing execution, acceptance, or locking are further caused to:
prevent acceptance or locking of any state record having an ethical score below a predetermined ethical minimum, and permitting further stability evaluation only for state records having an ethical score at or above the predetermined ethical minimum.

17. The computer program product of claim 11, wherein the one or more processors caused to restrict rollback are further caused to:
assign each accepted state record a unique, monotonically increasing timestamp as part of the time-sequenced locking; and
prevent modification of state records having earlier timestamps.

18. The computer program product of claim 11, wherein the one or more processors caused to immutably store scoring results are further caused to:
write an immutable scoring record that includes a content hash for the state record and the stability-related alignment score; and
record evaluation provenance by (i) generating a cryptographic hash of an evaluator configuration bundle and (ii) maintaining a running accumulator linking the cryptographic hash to a prior root to provide an extending proof-of-evaluation lineage.

19. A computer system for managing stability of iterative or recursive state transitions, the computer system comprising:
one or more processors;
one or more computer-readable storage media; and
program instructions stored on the one or more computer-readable storage media that, when executed by the one or more processors, cause the one or one or more processors to:
access a plurality of candidate recursion states associated with iterative or recursive state transitions;
create immutable units of information stored as state records in a non-erasing storage mechanism for the plurality of candidate recursion states, wherein each state record represents a respective state, computation, or decision in the recursive process and is distinct from prior state records for the plurality of candidate recursion states;
apply evaluation rules including predefined ethical parameters and one or more transformation gating thresholds to generate and immutably store scoring results comprising a stability-related alignment score that tracks recursion shifts across the state transitions;
enforce recursion stability by permitting transformation, propagation, or structural expansion of a given state record based on the transformation gating thresholds;
restrict rollback of the recursive process by generating lock records for accepted state records that satisfy the transformation gating threshold and enforcing time-sequenced locking that preserves an immutable, timestamp-ordered recursion history; and
automatically preventing execution, acceptance, or locking of any state record that violates predefined ethical parameters specified in the evaluation rules.

20. The computer system of claim 19, wherein the immutable units of information comprise pinions, and wherein each pinion represents a specific state, computation, or decision within the recursive process and is stored such that prior pinions remain unchanged and retrievable as additional pinions are added.
